(19) United States
(12) Patent Application Publication
(10) Pub. No.: US 2006/0056293 A1
(43) Pub. Date: Mar. 16, 2006

(54) Device and method for port assignment

(76) Inventors: Atsuya Kumagai, KawasakI (JP); Daiki Nakatsuka, Yokohama (JP); Mitsuru Ikezawa, Sagamihara (JP); Naoko Iwami, Sagamihara (JP)

Correspondence Address: MATTINGLY, STANGER & MALUR, P.C.;ATTORNEYS AT LAW, SUITE 370, 1800 DIAGONAL ROAD, ALEXANDRIA, VA, 22314, US

(21) Appl. No.: 10/986,496

(22) Filed: Nov. 12, 2004

(30) Foreign Application Priority Data
Sep. 10, 2004 (JP) 2004-263163

(51) Int. Cl. H04L 12/26

(52) U.S. Cl. 370/229

(57) ABSTRACT

A port assignment device capable of properly distributing loads on each of a plurality of ports is provided. The device assigning a plurality of ports, storing data from external devices via a network in a plurality of storage modules and managing the data in the storage modules by a plurality of targets processing initiator commands from the external devices, to the targets includes a load information storage module which stores load information indicating a load on each port assigned to each of the targets and a processing module which alters the port assignment to each target so as to disperse the load on each port based on the load information stored in the load information storage module. It then becomes possible to control amounts of data to be transmitted or received, that is, to properly distribute such amounts of data.

### INCORPORATION BY REFERENCE

The present application claims priority from Japanese application JP2004-263163 filed on Sep. 10, 2004, the content of which is hereby incorporated by reference into this application.

### BACKGROUND OF THE INVENTION

The present invention relates to a port assignment device and a port assignment method for dispersing the load on each port and thereby distributing the loads on the ports over the ports.

As SANs (Storage Area Networks) connecting server devices and a storage device together by a private network, FC-SANs configured by fiber channels have been the mainstream. Meanwhile, IP-SANs configured by IP (Internet Protocol) networks are becoming widespread in recent years. The IP-SANs have the advantage of being implementable at lower costs compared to FC-SANs.

In the IP, a device at the transmitting end (source) generates a packet by adding an IP header (containing information such as an IP address) to a TCP segment which will be explained later and transmits the generated packet. The packet is successively relayed by relaying devices and thereby delivered to a device at the receiving end (destination). In an IP network, the so-called “congestion” (concentration of a vast number of packets to a relaying device or the device at the receiving end, hampering effective communication) can occur. When such congestion has occurred, the packets are discarded. Functions such as retransmission of the discarded packets are provided by the TCP (Transmission Control Protocol).

In the TCP, when a TCP connection has been established between a source TCP port and a destination TCP port, the device at the transmitting end generates a TCP segment by adding a TCP header (containing information such as a port number) to data and transmits the generated TCP segment (data) to the destination. Meanwhile, the device at the receiving end which received the data returns an acknowledgement to the source. If the arrival of the data to the destination can not be confirmed (that is, if the acknowledgement is not received) for a prescribed time period, the device at the transmitting end judges that congestion has occurred and retransmits the TCP segments (of which the arrival could not been confirmed) after reducing the “window size” (the number of bytes that the source is allowed to transmit without the reception of the acknowledgement from the destination).

The iSCSI (Internet Small Computer System Interface) is a protocol for realizing an IP-SAN according to the TCP/IP. The ISCSI lets commands and data be exchanged between a program requesting data input/output and a program responding to the request. In the ISCSI, the program transmitting a request command for data read/write, etc. (or a device running the program) is called an “initiator” and the program responding to the request (or a device running the program) is called a “target”. The relationship between the initiator and the target exchanging commands and data is called a “session”. An iSCSI session is implemented by one or more TCP connections.

In the IP-SAN, one or more targets can be defined in a storage device, and one or more storage ports can be assigned to a target. A storage device can communicate data with a server device by use of a plurality of TCP connections. Therefore, deterioration of throughput caused by congestion at a storage port can be avoided by distributing the transmission/reception load over a plurality of storage ports.

In conventional technology, a manager or administrator of the storage device previously assigns ports to each target manually for the distribution of the transmission/reception load over a plurality of storage ports (see WO 2004/038554 A2).

### SUMMARY OF THE INVENTION

In such a case where a plurality of storage ports are assigned to a target, the manager of the storage device is required to determine a proper number of ports that should be assigned to each target, by previously estimating the transmission/reception load (data amount) on the storage ports per unit time in regard to each target.

It is therefore the primary object of the present invention to provide a device capable of resolving the above problem and automatically controlling the distribution of the transmission/reception load over a plurality of storage ports (hereinafter referred to as a “port assignment device”).

In accordance with an aspect of the present invention, there is provided a port assignment device which assigns a plurality of ports of a storage device (storing data sent from one or more external devices connected via a network in a plurality of storage modules and logically managing the data in the storage modules by a plurality of targets processing initiator commands sent from the external devices) to the targets, comprising: a load information storage module which stores load information indicating a load on each port assigned to each of the targets; and a processing module which alters the port assignment to each target so as to disperse the load on each port based on the load information stored in the load information storage module.

By such a configuration of the port assignment device, the load information on each port of the storage device is stored by the load information storage module. The load information indicates the reception load or transmission load. The port assignment device lets the processing module monitor the load information stored by the load information storage module, therefore, the port assignment to each target can be altered so as to disperse the load on each port and distribute the loads on the ports over the ports. Therefore, each external device is allowed to log in to or log out of the storage device 300 properly according to the result of the port assignment.

By the present invention, the congestion occurring to a port of the storage device can be prevented effectively.

### BRIEF DESCRIPTION OF THE DRAWINGS

The objects and features of the present invention will become more apparent from the consideration of the following detailed description taken in conjunction with the accompanying drawings, in which:

FIG. 1 is a schematic block diagram showing a computer system employing a port assignment device in accordance with a first embodiment of the present invention;

FIG. 2 is a block diagram showing memory contents of a memory of a server device of the computer system;

FIG. 3 is a table showing an example of target information;

FIG. 4 is a block diagram showing memory contents of a memory of a storage device of the computer system;

FIG. 5 is a table showing an example of system information;

FIG. 6 is a table showing an example of load information;

FIG. 7 is a table showing memory contents of a memory of the port assignment device;

FIG. 8 is a table showing an example of configuration information;

FIG. 9 is a sequence chart showing a discovery process executed by an initiator;

FIG. 10 is a flow chart showing a target information registration process which is executed by the port assignment device;

FIG. 11 is a flow chart showing the discovery process which is executed by a server device;

FIG. 12 is a flow chart showing a target information notification process which is executed by the port assignment device;

FIG. 13 is a flow chart showing a process for updating the system information;

FIG. 14 is a flow chart showing a process for generating the load information table;

FIG. 15 is a sequence chart showing a process executed by the port assignment device for obtaining the load information from the storage device;

FIG. 16 is a flow chart showing a reception load measurement process executed by the storage device;

FIG. 17 is a flow chart showing a load information notification process executed by the storage device;

FIG. 18 is a flow chart showing a load monitoring process executed by the port assignment device;

FIG. 19 is a sequence chart showing the operation of the port assignment device for additionally assigning a port to a target;

FIG. 20 is a flow chart showing a port assignment addition process and a log-in instruction process executed by the port assignment device;

FIG. 21 is a sequence chart showing the operation of the port assignment device for releasing a port that has been assigned to a target;

FIG. 22 is a flow chart showing a port assignment release process and a out-out instruction process executed by the port assignment device;

FIG. 23 is a flow chart showing a log-in process executed by a server device;

FIG. 24 is a flow chart showing a log-out process executed by a server device;

FIG. 25 is a schematic block diagram showing a computer system employing a port assignment device in accordance with a second embodiment of the present invention;

FIG. 26 is a block diagram showing memory contents of a memory of the port assignment device;

FIG. 27 is a flow chart showing a load measurement process and a load monitoring process executed by the port assignment device;

FIG. 28 is a flow chart showing a port assignment addition process and a log-in instruction process executed by the port assignment device;

FIG. 29 is a flow chart showing a port assignment release process and a log-out instruction process executed by the port assignment device; and

FIG. 30 is a table showing another example of the system information.

### DESCRIPTION OF THE EMBODIMENTS

Referring now to the drawings, a description will be given in detail of preferred embodiments in accordance with the present invention.

### Embodiment 1

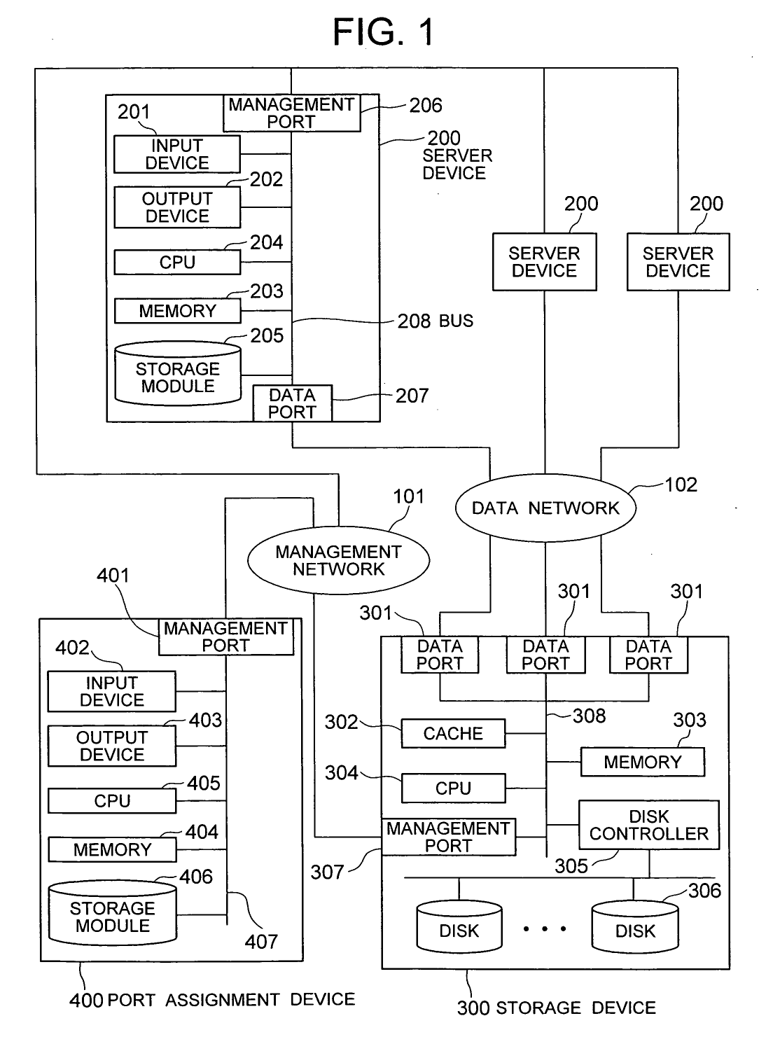

FIG. 1 is a schematic block diagram showing a computer system employing a port assignment device in accordance with a first embodiment of the present invention. As shown in FIG. 1, the computer system includes a plurality of (three in FIG. 1) server devices 200, a storage device 300 and a port assignment device 400 which are connected together by a management network 101. The server devices 200 (external devices) and the storage device 300 are connected together by a data network 102. The management network 101 and the data network 102 are IP networks like the Internet. The management network 101 and the data network 102 can also be integrated into one network. In this case, the same port can be used as both a data port and a management port in each device 200 or 300.

The computer system shown in FIG. 1 is a system which inputs and outputs data by use of the iSCSI protocol. The ISCSI is a protocol for the transmission/reception of SCSI commands (commands used by an initiator, hereinafter referred to as “initiator commands”) and data (which are used for the communication between the storage device 300 and the server devices 200) via an IP network. The initiator commands include read requests and write requests, for example.

The computer system includes ISCSI initiators which issue SCSI commands and thereby request read/write processes (hereinafter simply referred to as “initiators”) and iSCSI targets which execute the processes (hereinafter simply referred to as “targets”). Concretely, each server device 200 includes an initiator and the storage device 300 includes targets. To be more precise, the initiator and the targets are logical devices that are defined by iSCSI names. Specifically, a combination of a TCP port number and an IP address corresponds to an iSCSI name.

An initiator or a target generates an ISCSI PDU (Protocol Data Unit) by capsulating a SCSI command and data. The iSCSI PDU is a unit of data handled by the iSCSI protocol. Subsequently, a server device 200 or the storage device 300 partitions the iSCSI PDU into some packets and transmits the packets via TCP connections provided by the TCP/IP. Meanwhile, the server device 200 or storage device 300 receives packets via TCP connections, generates iSCSI PDUs from the received packets, and reconstructs SCSI commands and data. Incidentally, an iSCSI PDU can either be an iSCSI PDU of a request message (containing both a SCSI command and data) or an iSCSI PDU containing data only.

Each server device 200 is an information processing device which executes applications involving data input/output from/to the storage device 300 by use of the iSCSI protocol. In other words, each server device 200 makes access to the storage device 300 via the data network 102 and reads/writes data according to the iSCSI protocol. Incidentally, each server device 200 is assumed to include an initiator. In order to discriminate among the initiators, each initiator is provided with an iSCSI name. The iSCSI names of the server devices 200 are “I1”, “I2” and “I3”, respectively.

Each server device 200 includes an input device 201, an output device 202, a memory 203, a CPU 204, a storage module 205, a management port 206, a data port 207, and a bus 208 connecting the elements 201-207 together. The input device 201 includes a keyboard, a mouse, etc. The output device 202 includes a display, a printer, etc. The memory 203 stores prescribed programs and data which will be explained later. The CPU 204 carries out various processes which will be described later by running the programs stored in the memory 203.

The storage module 205 is composed of an HDD (Hard Disk Drive), etc. The storage module 205 stores the program and data which are loaded onto the memory 203 when the server device 200 is activated. The management port 206 is a device for transmitting and receiving packets containing information for the control of the system to/from the port assignment device 400 via the management network 101. The data port 207 is a device for transmitting and receiving packets obtained by partitioning iSCSI PDUs to/from the storage device 300 via the data network 102. Incidentally, the server device 200 shown in FIG. 1 is only an example and the composition of the server device 200 is not restricted to that of FIG. 1. For example, each server device 200 may be provided with two or more data ports 207. Further, each server device 200 may include two or more initiators.

The storage device 300 is a device having the function as storage for the server devices 200. The storage device 300 includes three targets. The iSCSI names for discriminating among the targets are “T1”, “T2” and “T3”. The storage device 300 includes data ports (storage ports) 301, a cache 302, a memory 303, a CPU 304, a disk controller 305, at least one disk 306, a management port 307, and a bus 308 connecting the elements 301-307 together.

Each data port 301 is a device for transmitting and receiving packets obtained by partitioning iSCSI PDUs to/from the server devices 200 via the data network 102. Each data port 301 is identified by an IP address. The storage device 300 has one or more (three in FIG. 1) data ports 301. In this description, each data port 301 will also be abbreviated as a “port”. The cache 302 is a memory for temporarily storing data in order to increase the access speed. The memory 303 stores a prescribed program (explained later) and data. The CPU 304 carries out various processes which will be described later by running the programs stored in the memory 303.

The disk controller 305 controls data input/output to/from the disks 306 as storage modules. The disk controller 305 may also carry out processes corresponding to the RAID (Redundant Array of Independent Disks). The disks 306 store data which are read/written by the server devices 200 and the program and data which are loaded onto the memory 303 when the storage device 300 is activated. The management port 307 is a device for transmitting and receiving packets containing information for the control of the system to/from the port assignment device 400 via the management network 101. Incidentally, the storage device 300 shown in FIG. 1 is only an example and the composition of the storage device 300 is not restricted to that of FIG. 1. For example, the storage device 300 may include one or two, or four or more targets.

The port assignment device 400 is a device for managing information on the storage device 300 while instructing the server devices 200 to log in, log out, etc. depending on the load status of each storage port 301. The port assignment device 400 includes a management port 401, an input device 402, an output device 403, a memory 404 (load information storage module), a CPU 405 (processing module), a storage module 406, and a bus 407 connecting the elements 401-406 together.

The management port 401 is a device for transmitting and receiving packets containing information for the control of the system to/from the server devices 200 and the storage device 300 via the management network 101. The input device 402 includes a keyboard, a mouse, etc. The output device 403 includes a display, a printer, etc. The memory 404 stores prescribed programs and data which will be explained later. The CPU 405 carries out various processes which will be described later by running the programs stored in the memory 404. The storage module 406 stores the program and data which are loaded onto the memory 404 when the port assignment device 400 is activated. Incidentally, the port assignment device 400 shown in FIG. 1 is only an example and the composition of the port assignment device in accordance with the present invention is not restricted to that of FIG. 1.

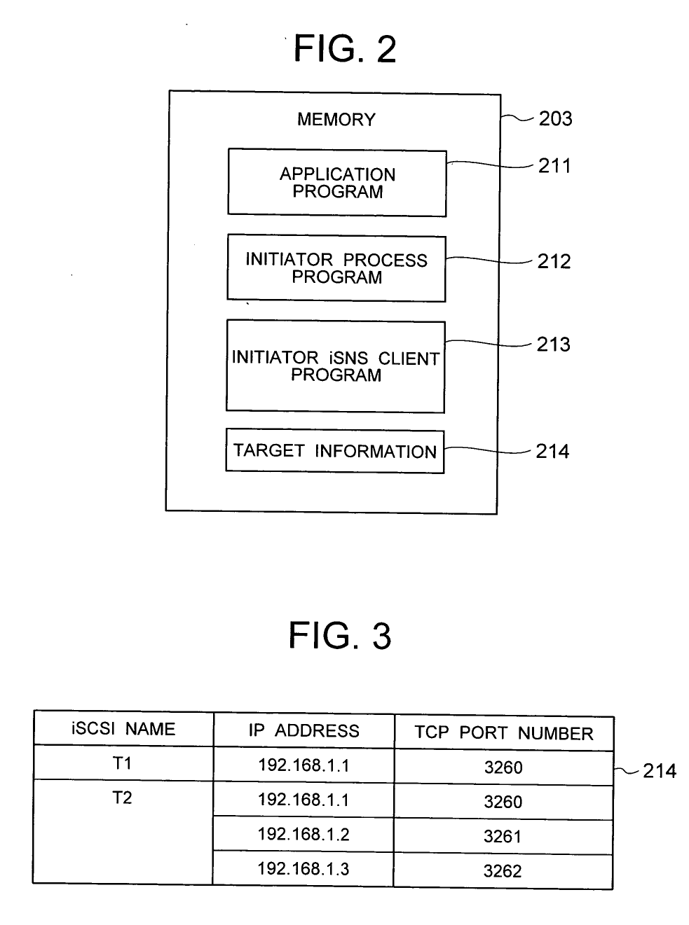

In the following, the detailed composition of the server device 200 will be described referring to FIG. 2. FIG. 2 is a block diagram showing memory contents of the memory 203 of the server device 200. The memory 203 has stored an application program 211, an initiator process program 212, an initiator iSNS (Internet Storage Name Service) client program 213 and target information 214. The application program 211 is a program for executing prescribed processes, which serves as triggers for data input/output to/from the storage device 300.

The initiator process program 212 is a program for executing processes of the iSCSI protocol and a discovery process. The “discovery process” means a process regarding a procedure for letting an initiator acquire information on targets to which the initiator can log in. The CPU 204 shown in FIG. 1 executes the processes of the ISCSI protocol by running the initiator process program 212. Specifically, the CPU 204 converts data to be written by the application program 211 into an iSCSI PDU format of a prescribed length, transmits iSCSI PDUs containing request messages and iSCSI PDUs containing data only to the storage device 300, etc. By running the initiator process program 212, the CPU 204 also carries out an iSCSI log-in (hereinafter simply referred to as a “log-in”) or an iSCSI log-out (hereinafter simply referred to as a “log-out”) to/from a target defined in the storage device 300, according to an instruction from the port assignment device 400. The operation of the server device 200 for the processes will be described in detail later.

The initiator iSNS client program 213 is a program for executing the discovery process. The CPU 204 shown in FIG. 1 runs the initiator iSNS client program 213 and thereby inquires of the port assignment device 400 about information on targets to which logging in is possible and receives a response to the inquiry from the port assignment device 400 (discovery process). Details of the operation will be described later.

The target information 214 is information on targets to which the initiator can log in. FIG. 3 is a table showing an example of the target information. The target information 214 is defined in the storage device 300. For example, the target information 214 includes an iSCSI name of each target and an IP address and a TCP port number for logging in to each target as shown in FIG. 3.

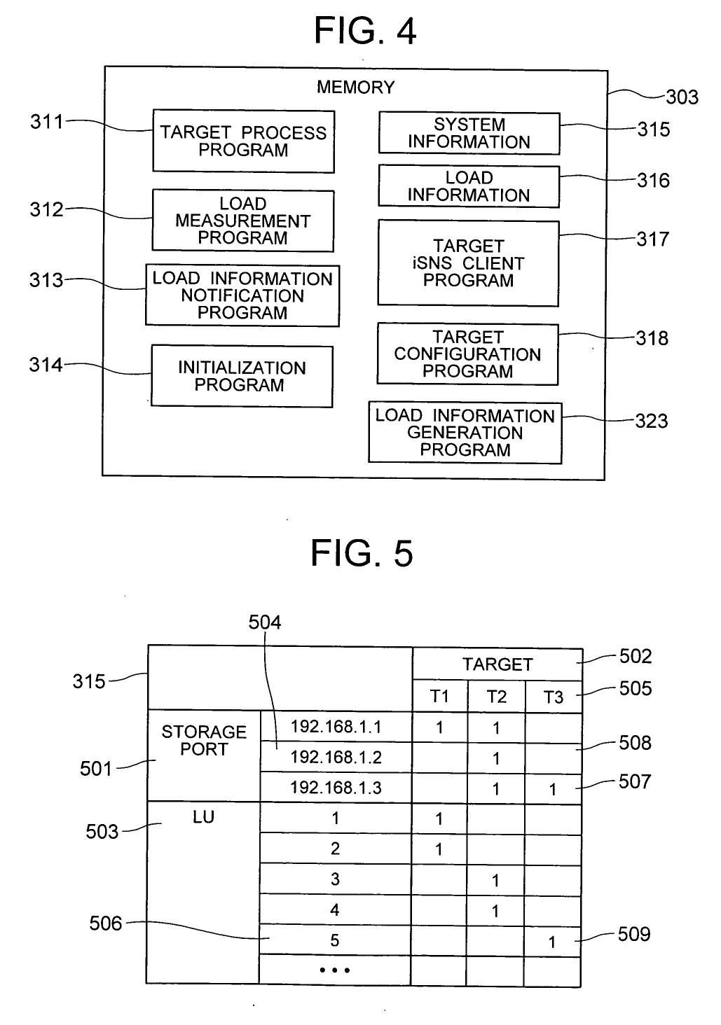

In the following, the detailed composition of the storage device 300 will be described referring to FIG. 4. FIG. 4 is a block diagram showing memory contents of the memory 303 of the storage device 300. The memory 303 has stored a target process program 311, a load measurement program 312, a load information notification program 313, an initialization program 314, system information 315, load information 316, a target iSNS client program 317, a target configuration program 318, and a load information generation program 323.

The target process program 311 is a program for executing processes of the iSCSI protocol. The CPU 304 shown in FIG. 1 executes the processes of the iSCSI protocol by running the target process program 311. Specifically, the CPU 304 transmits an iSCSI PDU of a message (response message) as a response to a request message from an initiator of a server device 200, receives iSCSI PDUs of data, etc. By running the target process program 311, the CPU 304 also counts the cumulative amount of data received by each storage port 301 regarding each initiator and each target, on each reception of write data.

The load measurement program 312 is a program for measuring the amount of data received by each storage port 301 per unit time (hereinafter referred to as a “reception load”). The CPU 304 shown in FIG. 1 runs the load measurement program 312 and thereby measures the number of bits received by each storage port 301 per unit time regarding each combination of an initiator as the source and a target as the destination. By the CPU 304 running the load measurement program 312, the load information 316 indicating the load on each port is stored in the memory 303.

The load information notification program 313 is a program for notifying the port assignment device 400 of the load information 316. The CPU 304 shown in FIG. 1 runs the load information notification program 313 and thereby notifies the load information 316 to the port assignment device 400. The operation of the CPU 304 running the load information notification program 313 will be described in detail later.

The system information 315 is an information table indicating the association of each data port (storage port) 301 with targets, while indicating the association of each LU (Logical Unit) with targets. The “LU” is a unit obtained by partitioning a disk 306 shown in FIG. 1 into a plurality of virtual logical disks by the disk controller 305 shown in FIG. 1.

FIG. 5 is a table showing an example of the system information 315 (table). In the table shown in FIG. 5, the correspondence between storage ports 501 and targets 502 has been set, together with the correspondence between LUs 503 and the targets 502. Specifically, an IP address 504 has been set to each storage port 501 and an iSCSI name 505 has been set to each target 502. To each LU 503, an LUN (Logical Unit Number) 506 as a logical classification (1, 2, etc.) of the LU has been set. A value “1” set in a cell of a target 502 means that the target has been associated with a storage port 501 (301) or an LU 503 corresponding to the cell. Meanwhile, a null value (blank) set in a cell of a target 502 means that the target has not been associated with a storage port 501 or an LU 503 corresponding to the cell.

For example, a cell 507 where a target “T3” and an IP address “192.168.1.3” intersect with each other has been set to “1”, which indicates that the target “T3” can transmit/receive data using a storage port 301 identified by the IP address “192.168.1.3”. Meanwhile, a cell 508 where the target “T3” and an IP address “192.168.1.2” intersect with each other has been set to a null value (blank), which indicates that the target “T3” can not use a storage port 301 identified by the IP address “192.168.1.2”. A cell 509 where the target “T3” and an LU “5” intersect with each other has been set to “1”, which indicates that the target “T3” and the LU “5” have been associated with each other. In this case, the target “T3” reads/writes data from/to the LU “5”.

Referring again to FIG. 4, the initialization program 314 stored in the memory 303 is a program for initializing the system information 315. The CPU 304 shown in FIG. 1 runs the initialization program 314 in an initialization process of the storage device 300 (when the storage device 300 is turned on, for example). By running the initialization program 314, the CPU 304 obtains the IP address of each storage port 301, the LUN (Logical Unit Number) of each LU which has been set and the iSCSI name of each target which has been set, and generates the system information 315 (table). The CPU 304 which generated the system information 315 also generates the load information 316 by calling a subroutine B which will be explained later. Information to be registered first with the system information 315 is inputted by the manager, etc. to the storage device 300 through the input device 402, etc.

The load information 316 stored in the memory 303 is information indicating the amount of data received by each storage port 301 per unit time (reception load) which has been measured by the load measurement program 312. The load information 316 is updated at prescribed time intervals by a load measurement process which will be described later.

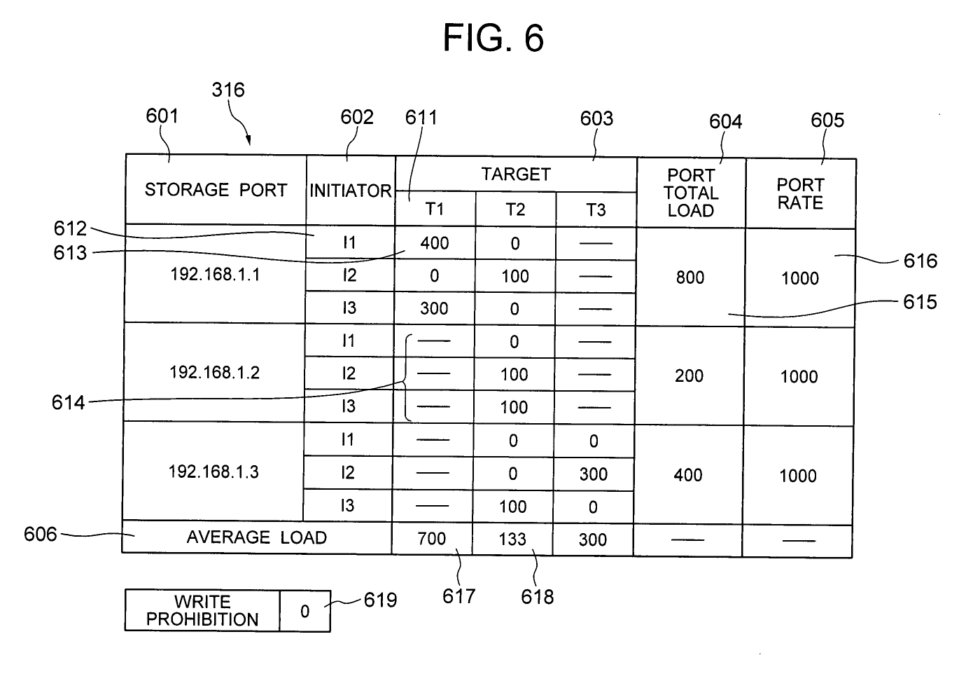

FIG. 6 is a table showing an example of the load information 316 (table). In the load information 316 shown in FIG. 6, storage ports 601, initiators 602, targets 603, port total loads 604 and port rates 605 are associated with one another. Specifically, an IP address has been set to each storage port 601 and an iSCSI name has been set to each initiator 602 and target 603. In this table, an average load 606 has been stored for each target 603. The load information 316 includes the number of received bits (Mbps: Megabits per second) measured for each combination of an IP address, an iSCSI name of an initiator and an iSCSI name of a target. The port total load 604 is the total number of bits received by each storage port 301 per unit time (Mbps). The port rate 605 (port communication speed) is the maximum number of bits that can be received by each storage port 301 per unit time (Mbps). The average load 606 of each target is an average obtained by dividing the total number of bits of the reception load (Mbps) regarding the target by the number of ports assigned to the target.

In a storage port 301 identified by an IP address “192.168.1.1” in the load information 316 of FIG. 6 for example, the number of bits (megabits) which a target “T1” received from an initiator “I1” per unit time is 400 (Mbps) as indicated by a cell 613. In a storage port 301 identified by an IP address “192.168.1.2”, a null value (blank) has been set to each cell 614 of the target “T1”, which indicates that the target “T1” is not using the storage port 301 identified by the IP address “192.168.1.2” according to the system information 315 (see FIG. 5). The load information 316 of FIG. 6 indicates that the port total load 604 of the storage port 301 identified by the IP address “192.168.1.1” is 800 (Mbps) as seen in a cell 615, and the port rate 605 of the storage port is 1000 (Mbps) as seen in a cell 616.

In the load information 316 of FIG. 6, when a value “1” is set in a cell 619, it means that a program stored in the memory 303 has prohibited other programs from writing data to the load information 316 (that is, the load information 316 has been locked). On the other hand, a value “0” set in a cell 619 means that the load information 316 has not been locked.

The explanation of the memory 303 of the storage device 300 will be continued below. Referring to FIG. 4, the target iSNS client program 317 is a program for notifying the port assignment device 400 of information on the targets which have been defined in the storage device 300 (target information). The CPU 304 shown in FIG. 1 runs the target iSNS client program 317 and thereby notifies information on the iSCSI name, the IP address, the TCP port number, etc. of each target (target information) to the port assignment device 400 (discovery process). Details of the discovery process will be described later.

The target configuration program 318 is a program for updating the system information 315 when a new storage port 301 is added to a prescribed target, when a storage port 301 has become unusable, or when an instruction from the port assignment device 400 is received. The operation of the CPU 304 running the target configuration program 318 will be described in detail later.

The load information generation program 323 is a program for adding or deleting an entry (item) to/from the load information 316 based on the update of the system information 315. The operation of the CPU 304 running the load information generation program 323 will be described in detail later.

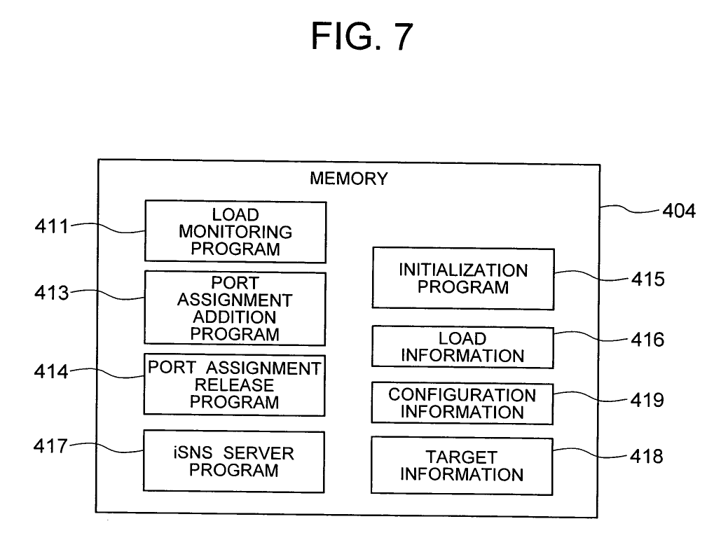

In the following, the detailed composition of the port assignment device 400 will be described referring to FIG. 7. FIG. 7 is a table showing memory contents of the memory 404 of the port assignment device 400. The memory 404 has stored a load monitoring program 411, a port assignment addition program 413, a port assignment release program 414, an initialization program 415, load information 416, an iSNS server program 417, target information 418 and configuration information 419.

The load monitoring program 411 is a program for requesting the notification of the load information 316 from the storage device 300 while updating and monitoring the load information 416. The CPU 405 shown in FIG. 1 runs the load monitoring program 411 and thereby requests the load information 316 stored in the memory 303 of the storage device 300. By running the load monitoring program 411, the CPU 405 also updates the load information 416 stored in the memory 404, while monitoring the reception load regarding each target by comparing the load information 416 with the configuration information 419 stored in the memory 404. The operation of the CPU 405 running the load monitoring program 411 will be described in detail later.

The port assignment addition program 413 is a program for newly assigning a storage port 301 to a target. The CPU 405 shown in FIG. 1 runs the port assignment addition program 413 and thereby assigns a new storage port 301 to a target under a high reception load, while instructing a server device 200 to log in using the newly assigned storage port 301. The operation of the CPU 405 running the port assignment addition program 413 will be described in detail later. Incidentally, the CPU 405 running the port assignment addition program 413 functions as a new assignment processing module.

The port assignment release program 414 is a program for releasing the assignment of a storage port 301 to a target. The CPU 405 shown in FIG. 1 runs the port assignment release program 414 and thereby releases the assignment of a storage port 301 to a target under a low reception load, while instructing a server device 200 to log out of a connection using the released storage port 301. The operation of the CPU 405 running the port assignment release program 414 will be described in detail later. Incidentally, the CPU 405 running the port assignment release program 414 functions as an assignment release processing module.

The initialization program 415 is a program for initializing the load information 416. By running the initialization program 415, the CPU 405 shown in FIG. 1 sets initial values prestored in the storage module 406 as initial values of the load information 416 when the port assignment device 400 is turned on, or sets initial values inputted through the input device 402 of the port assignment device 400 as the initial values of the load information 416. While the initial value of each reception load in the load information 416 is set to 0 (Mbps) in this embodiment, the present invention is not restricted to such initial settings. Incidentally, the load information 416 is the load information 316 obtained from the storage device 300 and stored in the memory 404.

The iSNS server program 417 is a program for receiving the target information from the storage device 300 while responding to inquiries about the target information from the server devices 200. By running the iSNS server program 417, the CPU 405 shown in FIG. 1 receives the target information from the storage device 300 and updates the target information 418 stored in the memory 404, while notifying the target information 418 to a server device 200 in response to an inquiry from the server device 200. The operation of the CPU 405 running the iSNS server program 417 will be described in detail later. Incidentally, the target information 418 includes the iSCSI name, the IP address, the TCP port number, etc. of each target.

The configuration information 419 is information indicating reference values of the reception load on each port. Each reference value is set by the manager. The configuration information 419 is used as a reference when the port assignment device 400 instructs a server device 200 to log in or log out.

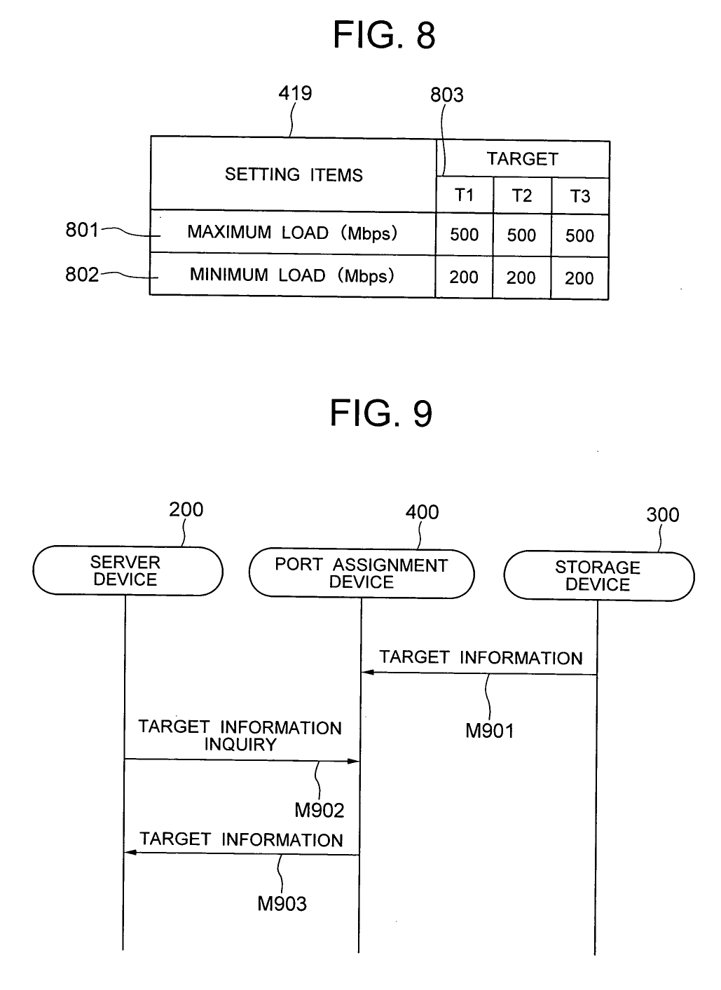

FIG. 8 is a table showing an example of the configuration information 419. In the table, a maximum load (upper limit) 801 means a criterion for judging whether a storage port 301 assigned to a target is under a high load or not, expressed in terms of the number of received bits per port (Mbps). Meanwhile, a minimum load (lower limit) 802 means a criterion for judging whether a storage port 301 assigned to a target is under a low load or not, expressed in terms of the number of received bits per port (Mbps).

In the example of FIG. 8, a storage port 301 assigned to a target “T1” is judged to be under a high load when the average of the reception load on the storage port 301 assigned to the target “T1” is over 500 (Mbps). Meanwhile, the storage port 301 assigned to the target “T1” is judged to be under a low load when the average reception load on the storage port 301 is under 200 (Mbps).

In the following, the operation of the server device 200, the storage device 300 and the port assignment device 400 in the computer system will be described in detail, in which the discovery process, the generation/update of the load information on a storage port 301, and port assignment by the port assignment device 400 will be explained in sequence.

First, the operation when an initiator of a server device 200 carries out the discovery process will be described referring to FIGS. 9 through 12 (see FIG. 1 as needed).

FIG. 9 is a sequence chart showing a discovery process executed by an initiator. When the port assignment device 400 requests the target information from the storage device 300 in response to an input by the manager through the input device 402, the storage device 300 sends a message M901 containing the target information to the port assignment device 400. The target information includes the iSCSI name, the IP address and the TCP port number of each target. Meanwhile, when a server device 200 sends a message M902 for inquiring the target information to the port assignment device 400 in response to an input by a user through the input device 201, the port assignment device 400 automatically transmits a message M903 containing the target information stored in the memory 303 to the server device 200.

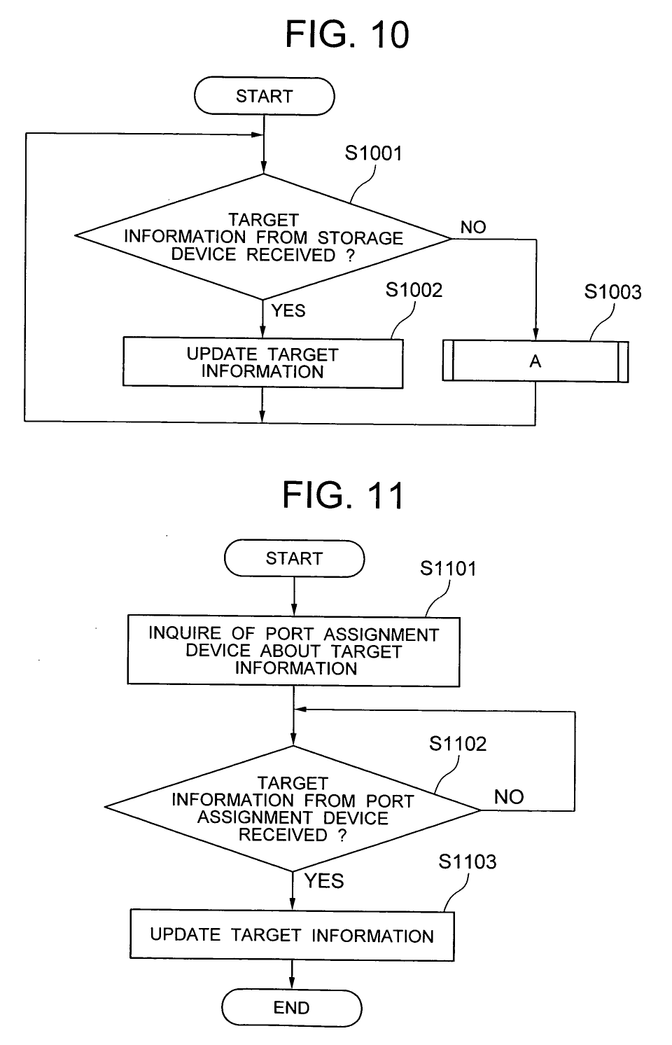

FIG. 10 is a flow chart showing a target information registration process which is executed by the port assignment device 400. The process is carried out by the CPU 405 of the port assignment device 400 by running the iSNS server program 417 stored in the memory 404. When the message M901 containing the target information is received from the storage device 300 (S1001: YES), the CPU 405 updates the target information 418 stored in the memory 404 (S1002). If the message M901 is not received from the storage device 300 (S1001: NO), the CPU 405 activates a subroutine A which will be explained later (S1003).

FIG. 11 is a flow chart showing the discovery process which is executed by a server device 200. The process is carried out by the CPU 204 of the server device 200 by running the iSNS client program 213 stored in the memory 203. The CPU 204 transmits the message M902 for inquiring the target information to the port assignment device 400 (S1101). Thereafter, when the message M903 containing the target information is received from the port assignment device 400 (S1102: YES), the CPU 204 updates the target information 214 stored in the memory 203 according to the received message M903 (S1103). Further, the CPU 204 displays the contents of the received message M903 (target information) on the output device 202. The CPU 204 waits for the message M903 until it is received from the port assignment device 400 (S1102: NO).

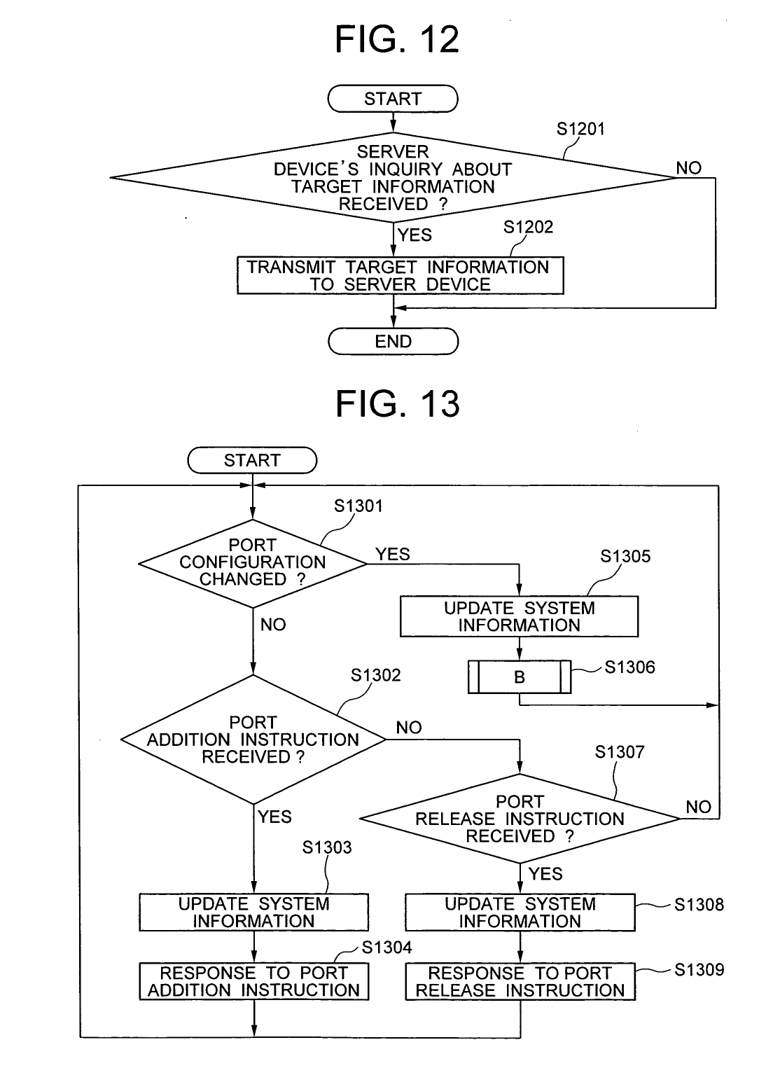

FIG. 12 is a flow chart showing a target information notification process which is executed by the port assignment device 400. The process is carried out by the CPU 405 of the port assignment device 400 by running the iSNS server program 417 stored in the memory 404. The process is the aforementioned subroutine A which is called in the step S1003 of FIG. 10. When the message M902 for inquiring the target information is received from a server device 200 (S1201: YES), the CPU 405 extracts the target information 418 from the memory 404 and transmits the message M903 containing the extracted target information 418 to the server device 200 (S1202). If no message M902 is received from a server device 200 (S1201: NO), the CPU 405 ends the subroutine A.

By the above operation, the user of the server device 200 can carry out a log-in by selecting a target and a storage port 301 by operating the input device 201 based on the obtained target information.

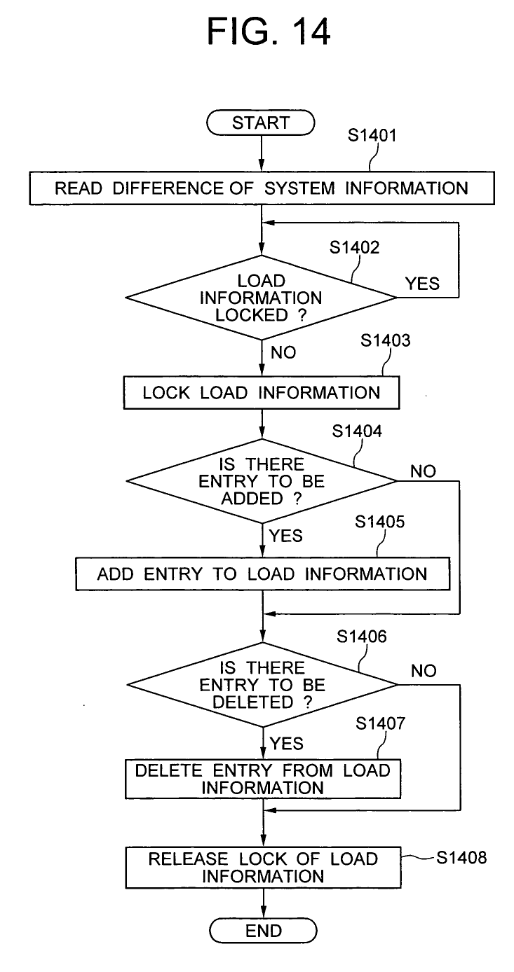

Next, the operation of the storage device 300 for generating the load information table 316 shown in FIG. 6 will be described referring to FIGS. 13 and 14 (see FIG. 1 as needed). Before generating the load information table 316, the storage device 300 updates the system information 315 (target configuration), that is, associates targets with storage ports 301 and with LUs. FIG. 13 is a flow chart showing the process for updating the system information 315 stored in the memory 303 of the storage device 300. The process is carried out by the CPU 304 by running the target configuration program 318 stored in the memory 303.

The CPU 304 checks IP addresses of all the available storage ports 301 of the storage device 300, compares the IP addresses with the system information 315 of FIG. 5 stored in the memory 303, and thereby judges whether the configuration of storage ports 301 has changed or not (S1301). When the port configuration is judged to have changed (S1301: YES), the CPU 304 updates the system information 315 stored in the memory 303 (S1305) while temporarily storing the difference between the system information after the update and that before the update in the memory 303. Subsequently, the CPU 304 executes the subroutine B (S1306) and returns to the step S1301. When the port configuration is judged to have not changed (S1301: NO), the CPU 304 executes a process from step S1302 which will be explained later.

FIG. 14 is a flow chart showing a process for generating the load information table 316 of the storage device 300. The process is carried out by the CPU 304 by running the load information generation program 323 stored in the memory 303. The process is the aforementioned subroutine B which is executed in the step S1306 of the system information update (target configuration) process. The subroutine B is executed also when the load information 316 is initialized.

The CPU 304 reads out the “difference between the system information after the update and that before the update” which has been temporarily stored in the memory 303 (S1401). Subsequently, the CPU 304 refers to the load information 316 and locks the load information 316 (sets a value “1” in the cell 619) (S1403) if it has not been locked (“0” is set in the cell 619) (S1402: NO). If the load information 316 has been locked, the CPU 304 waits until the lock is released (S1402: YES).

After the step S1403, the CPU 304 judges whether an entry of a storage port 301 should be added to the load information 316 based on the difference of the system information (S1404), and adds the entry to the load information 316 (S1405) if the addition is judged to be necessary (S1404: YES). The CPU 304 also judges whether an entry of a storage port 301 should be deleted from the load information 316 based on the difference of the system information (S1406), and deletes the entry from the load information 316 (S1407) if the deletion is judged to be necessary (S1406: YES). After the update of the load information 316, the CPU 304 releases the lock of the load information 316 (S1408) and ends the process.

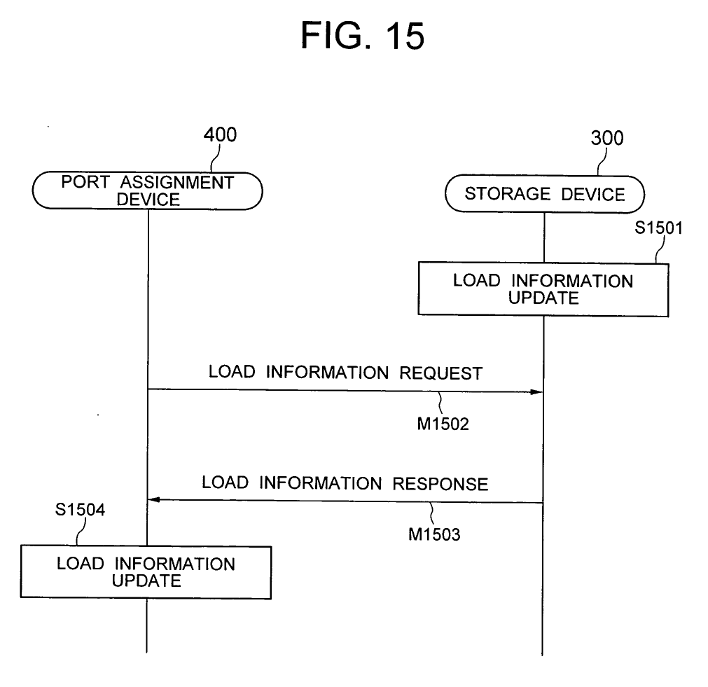

Next, the operation of the port assignment device 400 for updating the load information 416 will be described referring to FIGS. 15 through 18 (see FIG. 1 as needed). FIG. 15 is a sequence chart showing a process executed by the port assignment device 400 for obtaining the load information from the storage device 300. The storage device 300 automatically updates the load information 316 stored in the memory 303 at prescribed periods (S1501). Meanwhile, the port assignment device 400 transmits a message M1502 for requesting the load information to the storage device 300 in response to an input by the manager through the input device 402. The storage device 300 which received the message M1502 transmits a message M1503 containing the load information 316 to the port assignment device 400. Incidentally, the message M1503 also includes the system information 315. The port assignment device 400 receives the message M1503 from the storage device 300 and updates the load information 416 stored in the memory 404 based on the load information 316 contained in the received message M1503 (S1504). By the above process, the port assignment device 400 can update the load information 416.

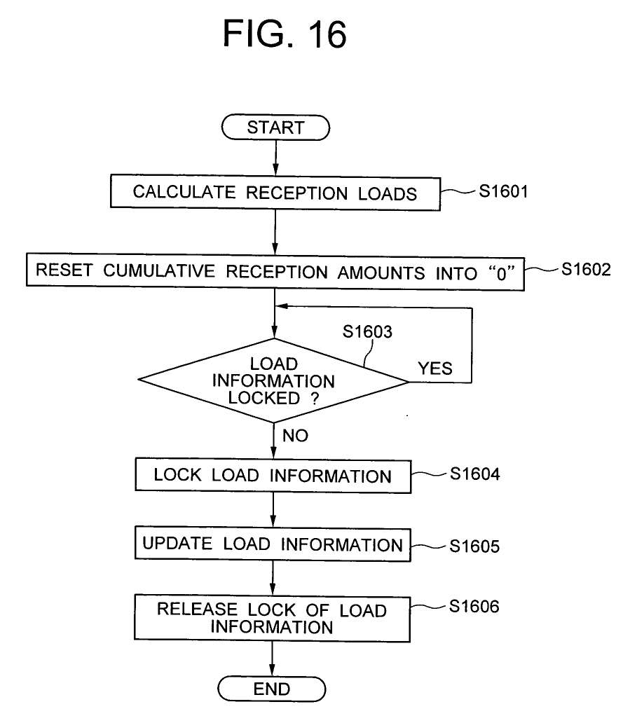

FIG. 16 is a flow chart showing a reception load measurement process executed by the storage device 300. The process is carried out by the CPU 304 by running the load measurement program 312 stored in the memory 303 at prescribed time intervals (every minute, for example). The CPU 304 calculates the number of received bits per unit time regarding each storage port 301, each initiator (as a source) and each target (as a destination), as the reception loads (S1601). The CPU 304 has successively counted the cumulative reception amount of each storage port 301 regarding each initiator and each target and accumulated the amounts in the memory 303 by running the target process program 311. Therefore, the CPU 304 calculates each reception load (the number of received bits per second, for example) by reading each cumulative reception amount from the memory 303 and dividing the cumulative reception amount by the prescribed time interval. The calculated reception loads are stored in the memory 303 in the form of the load information table shown in FIG. 6.

After calculating all the reception loads, the CPU 304 resets all the cumulative reception amounts stored in the memory 303 into “0” (S1602). Subsequently, the CPU 304 refers to the load information 316 and if the load information 316 has not been locked (if the cell 619 has the value “0”) (S1603: NO), the CPU 304 locks the load information 316 (sets the value “1” in the cell 619) (S1604) and updates the load information 316 (reception loads) stored in the memory 303 into the calculated reception loads (S1605). After the update of the load information 316, the CPU 304 releases the lock of the load information 316 (S1606). In the step S1603, if the load information 316 has been locked (S1603: YES), the CPU 304 waits until the lock is released.

Incidentally, the CPU 304 identifies the initiator and the target by identifying the TCP connection by the combination of the source IP address, the source TCP port number, the destination IP address and the destination TCP port number contained in the header of the received packet and judging which iSCSI session is using the TCP connection.

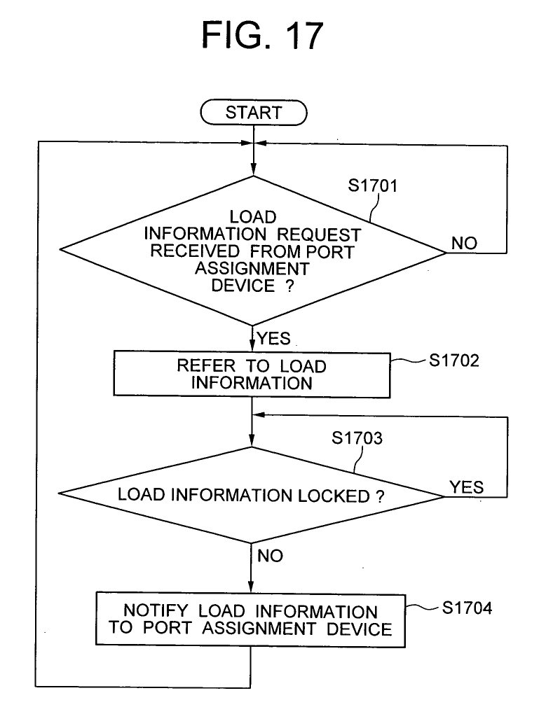

FIG. 17 is a flow chart showing a load information notification process executed by the storage device 300. The load information notification process of the storage device 300 is executed by the CPU 304 by running the load information notification program 313 stored in the memory 303. When the message M1502 requesting the load information 316 is received from the port assignment device 400 via the management port 307 (S1701: YES), the CPU 304 refers to the load information 316 stored in the memory 303 (S1702). In the step S1701, the CPU 304 waits until the message M1502 requesting the load information 316 is received from the port assignment device 400 (S1701: NO). After the step S1702, if the load information 316 has not been locked (S1703: NO), the CPU 304 transmits the message M1503 containing the load information 316 to the port assignment device 400 (S1704). In the step S1703, if the load information 316 has been locked (S1703: YES), the CPU 304 waits until the lock is released.

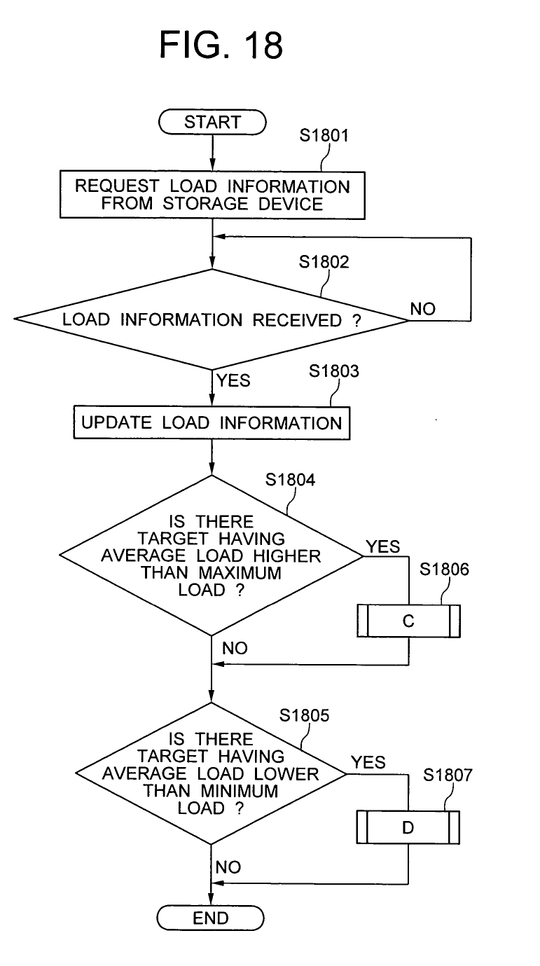

FIG. 18 is a flow chart showing a load monitoring process executed by the port assignment device 400. The process is carried out by the CPU 405 by periodically executing the load monitoring program 411 stored in the memory 404. The CPU 405 transmits the message M1502 for requesting the load information 316 to the storage device 300 via the management port 401 at prescribed time intervals (every minute, for example) (S1801). When the message M1503 containing the load information 316 is received from the storage device 300 (S1802: YES), the CPU 405 updates the load information 416 stored in the memory 404 based on the received load information 316 (S1803). In the step S1802, the CPU 405 waits until the message M1503 containing the load information 316 is received (S1802: NO).

After the step S1803, the CPU 405 refers to the load information 416 stored in the memory 404 and compares the average load 606 of each target contained in the load information 416 (see FIG. 6) with the maximum load 801 of each target contained in the configuration information 419 (see FIG. 8) stored in the memory 404. In the comparison, if there exists a target whose average load 606 is higher than the maximum load (upper limit) 801 (S1804: YES), the CPU 405 regards the target as a high load target and executes a subroutine C (explained later) to the high load target (S1806). Further, the CPU 405 compares the average load 606 of each target (see FIG. 6) with the minimum load 802 of each target contained in the configuration information 419 (see FIG. 8). In the comparison, if there exists a target whose average load 606 is lower than the minimum load (lower limit) 802 (S1805: YES), the CPU 405 regards the target as a low load target and executes a subroutine D (explained later) to the low load target (S1807).

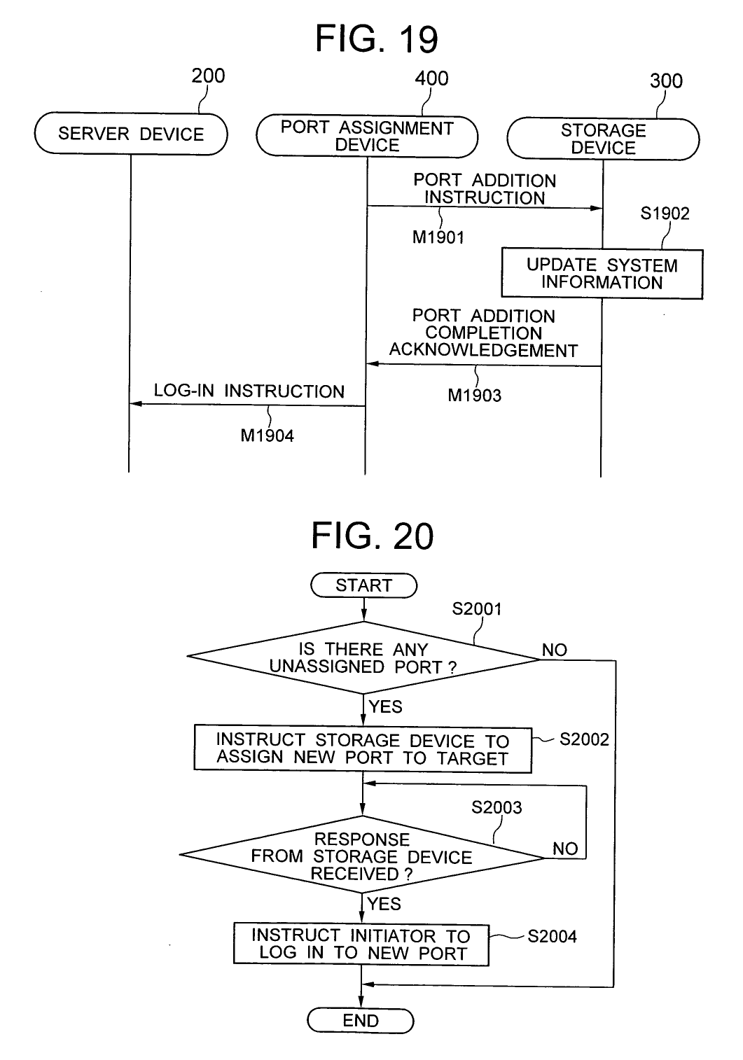

Next, the operation of the port assignment device 400 for assigning a new port to the storage device 300 and issuing an log-in instruction to a server device 200 will be described referring to FIGS. 19, 20 and 13 (see FIG. 1 as needed). FIG. 19 is a sequence chart showing the operation of the port assignment device 400 for additionally assigning a port to a target. The port assignment device 400 transmits a message M1901 for ordering the addition of a storage port 301 to the storage device 300. The storage device 300 which received the message M1901 updates the system information 315 (S1902) and returns an acknowledgement message M1903 indicating the completion of the port addition to the port assignment device 400. The port assignment device 400 which received the acknowledgement message M1903 transmits a message M1904, instructing the server device 200 to log in to the added storage port 301, to the server device 200 based on the received message M1903. By the above operation, the port assignment device 400 can assign an additional port to the storage device 300 and the server device 200 is allowed to log in to the added port.

FIG. 20 is a flow chart showing a port assignment addition process and a log-in instruction process executed by the port assignment device 400. The process is carried out by the CPU 405 by running the port assignment addition program 413 stored in the memory 404. The process is the aforementioned subroutine C which is called in the step S1806 executed by the CPU 405 running the load monitoring program 411. Therefore, the CPU 405 has judged the target under consideration as a high load target (see FIG. 18) before the execution of the subroutine C. In other words, the average load 606 of the target (see FIG. 6) is higher than the maximum load 801 of the target (see FIG. 8).

The CPU 405 checks the correspondence between IP addresses 501 and iSCSI names 505 by referring to the system information 315 (see FIG. 5) stored in the memory 404 together with the load information 416. If the CPU 405 judges that there is a storage port 301 that has not been assigned to any target (unassigned port) (S2001: YES), the CPU 405 issues the message M1901 (instructing the storage device 300 to newly assign (add) the unassigned port to the aforementioned high load target) to the storage device 300 (S2002). When there are two or more unassigned ports (unused ports), the CPU 405 assigns a randomly selected unassigned port to the high load target. If the CPU 405 judges that there is no storage port 301 as an unassigned port (S2001: NO), the process is ended.

When the message M1903 responding to the port addition instruction is received from the storage device 300 (S2003: YES), the CPU 405 issues the message M1904 to the server device 200 (initiator) that has logged in to the high load target and thereby instructs the initiator to log in to the newly assigned port (S2004). When there are two or more such initiators, the CPU 405 randomly selects an initiator to which the instruction is issued. If the response message M1903 is not received from the storage device 300 (S2003: NO), the CPU 405 waits until the message M1903 is received.

Next, a process executed by the storage device 300 for additionally assigning a port to a target will be described referring to FIG. 13. As mentioned above, FIG. 13 shows the process flow when the storage device 300 updates the system information 315 stored in the memory 303. The process is carried out by the CPU 304 by running the target configuration program 318. When the port configuration (configuration of storage ports 301) is judged to have not changed (S1301: NO), the CPU 304 judges whether or not the message M1901 ordering the addition of a port has been received from the port assignment device 400 (S1302). If the message M1901 has been received (S1302: YES), the CPU 304 updates the system information 315 (see FIG. 5) based on the message M1901 (S1303). In other words, the correspondence (association) between data storage ports and targets is updated. Thereafter, the CPU 304 returns the acknowledgement message M1903 (indicating the completion of the port addition) to the port assignment device 400 (S1304).

Concrete examples of the port assignment process and the log-in instruction process executed by the port assignment device 400 which has been explained referring to FIGS. 19, 20 and 13 will be described below referring to FIGS. 6 and 8. In the load information 316 shown in FIG. 6 for example, the average load 617 of the target T1 is 700 (Mbps), while the maximum load 801 of the target T1 in the configuration information 419 shown in FIG. 8 is 500 (Mbps). Therefore, the average load 617 of the target T1 has exceeded the maximum load 801. Meanwhile, two ports identified by the IP addresses “192.168.1.2” and “192.168.1.3” are the unassigned ports for the target T1 as shown in FIG. 6. In this case, the port assignment device 400 instructs the storage device 300 to newly assign (add) the storage port 301 identified by the IP address “192.168.1.2” to the target T1, for example. Further, the port assignment device 400 instructs a server device 200 (initiator I1 or I2) to log in to the added port.

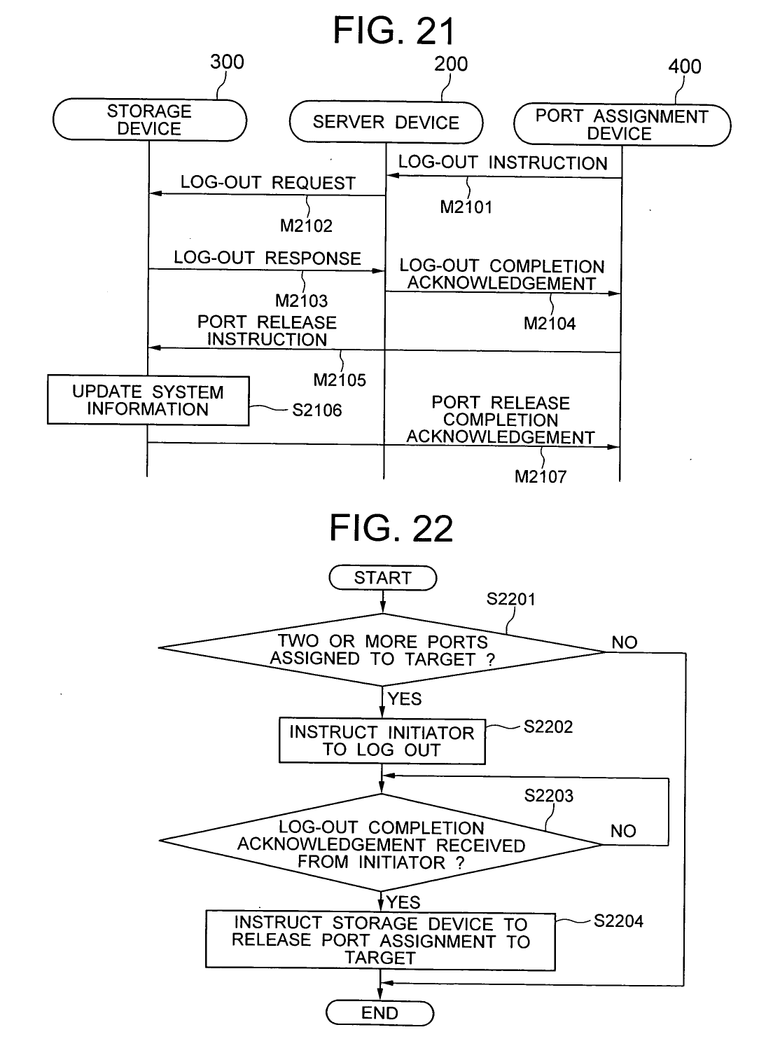

Next, the operation of the port assignment device 400 for releasing port assignment and issuing an log-out instruction to a server device 200 will be described referring to FIGS. 21, 22 and 13 (see FIG. 1 as needed). FIG. 21 is a sequence chart showing the operation of the port assignment device 400 for releasing a port that has been assigned to a target. First, the port assignment device 400 transmits a message M2101 (for instructing a server device 200 to log out) to the server device 200. The server device 200 which received the message M2101 transmits a message M2102 (for requesting a log-out from a storage port 301) to the storage device 300. The storage device 300 returns a log-out response message M2103 to the server device 200 that sent the message M2102 (completion of the log-out). The server device 200 which received the log-out response message M2103 transmits an acknowledgement message M2104 (indicating the completion of the log-out) to the port assignment device 400. The port assignment device 400 transmits a message M2105 (for instructing the storage device 300 to release a corresponding storage port 301) to the storage device 300 based on the acknowledgement message M2104 received from the server device 200. The storage device 300 updates the system information 315 (S2106) and transmits an acknowledgement message M2107 (indicating the completion of the port release) to the port assignment device 400. By the above operation, the port assignment device 400 can change the port assignment by releasing the port that has been assigned in the storage device 300 and the server device 200 can log out of the port released.

FIG. 22 is a flow chart showing a port assignment release process and a log-out instruction process executed by the port assignment device 400. The process is carried out by the CPU 405 by running the port assignment release program 414 stored in the memory 404. The process is the aforementioned subroutine D which is called in the step S1807 executed by the CPU 405 running the load monitoring program 411. Therefore, the CPU 405 has judged the target under consideration as a low load target (see FIG. 18) before the execution of the subroutine D. In other words, the average load 606 of the target (see FIG. 6) is lower than the minimum load 802 of the target (see FIG. 8).

The CPU 405 judges whether or not two or more storage ports 301 have been assigned to the low load target (S2201). If two or more storage ports 301 are judged to have been assigned to the low load target (S2201: YES), the CPU 405 transmits the message M2101 to a server device 200 (initiator) that has logged in to a storage port 301 randomly selected from the two or more storage ports 301 and thereby instructs the server device 200 (initiator) to log out of the connection using the storage port 301 (S2202). If the CPU 405 judged that one or less storage ports 301 have been assigned to the low load target (S2201: NO), the process is ended.

When the acknowledgement message M2104 (indicating the completion of the log-out) is received from the server device 200 (initiator) (S2203: YES), the CPU 405 issues the message M2105 (for instructing the storage device 300 to release the assignment of the storage port 301 to the low load target) to the storage device 300 (S2204). If the acknowledgement message M2104 (indicating the completion of the log-out) is not received from the server device 200 (initiator) (S2203: NO), the CPU 405 waits until the acknowledgement message M2104 is received.

Next, a process executed by the storage device 300 for releasing a port that has been assigned to a target will be described referring to FIG. 13. As mentioned above, FIG. 13 shows the process flow when the storage device 300 updates the system information 315 stored in the memory 303. The process is carried out by the CPU 304 by running the target configuration program 318. When the port configuration (configuration of storage ports 301) is judged to have not changed (S1301: NO) and the message M1901 (port addition instruction) has not been received from the port assignment device 400 (S1302: NO), the CPU 304 judges whether the message M2105 (port release instruction) has been received or not (S1307). When the message M2105 is received (S1307: YES), the CPU 304 updates the system information 315 according to the instruction of the message M2105 (S1308) and transmits the acknowledgement message M2107 (indicating the completion of the port release) to the port assignment device 400 (S1309).

Concrete examples of the port assignment release process and the log-out instruction process executed by the port assignment device 400 which has been explained referring to FIGS. 21, 22 and 13 will be described below referring to FIGS. 6 and 8. In the load information 316 shown in FIG. 6 for example, the average load 618 of the target T2 is 133 (Mbps), while the minimum load 802 of the target T2 in the configuration information 419 shown in FIG. 8 is 200 (Mbps). Therefore, the average load 618 of the target T2 has fallen below the minimum load 802. Meanwhile, three ports identified by the IP addresses “192.168.1.1”, “192.168.1.2” and “192.168.1.3” have been assigned to the target T2 as shown in FIG. 6. In this case, the port assignment device 400 instructs two server devices 200 (initiators I1 and I2) to log out of the connections using the storage port 301 identified by the IP address “192.168.1.2” (M2101). Further, when the CPU 405 has confirmed the completion of the log-out by the initiators I1 and I2 (M2104), the CPU 405 instructs the storage device 300 to release the assignment of the storage port 301 with the IP address “192.168.1.2” to the target T2, that is, to update the system information 315 (see FIG. 5) (M2105).

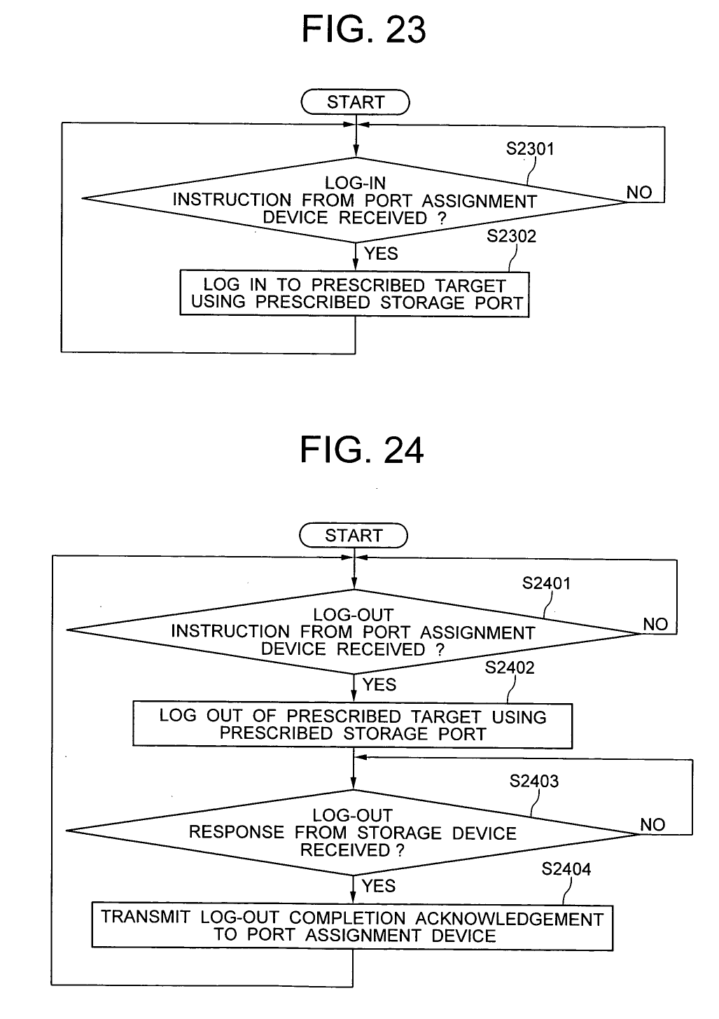

Next, a log-in process and a log-out process executed by a server device 200 will be described referring to FIGS. 23 and 24. FIG. 23 is a flow chart showing the log-in process executed by the server device 200. The process is carried out by the CPU 204 of the server device 200 by running the initiator process program 212. When the message M1904 (log-in instruction) is received from the port assignment device 400 (S2301: YES), the CPU 204 executes a process for logging in to a prescribed target using information on an iSCSI name and a storage port 301 of the storage device 300 contained in the message M1904 (S2302). If the message M1904 is not received (S2301: NO), the CPU 204 waits until the message M1904 is received.

FIG. 24 is a flow chart showing the log-out process executed by the server device 200. The process is carried out by the CPU 204 by running the initiator process program 212. When the message M2101 (log-out instruction) is received from the port assignment device 400 (S2401: YES), the CPU 204 executes a process for logging out of a prescribed target using information on an iSCSI name and a storage port 301 of the storage device 300 contained in the message M2101 (S2402). If the message M2101 is not received (S2401: NO), the CPU 204 waits until the message M2101 is received. After the step S2402, when the log-out response message M2103 is received from the storage device 300 (S2403: YES), the CPU 204 transmits the acknowledgement message M2104 (indicating the completion of the log-out) to the port assignment device 400 (S2404) and returns to the step S2401.

While the reception loads on the storage ports 301 when the server devices 200 write data to the storage device 300 have been described in the above embodiment, transmission loads on the storage ports 301 when the server devices 200 read data from the storage device 300 can also be handled similarly. By the above embodiment, the port assignment device 400 can properly distribute the transmission/reception loads over the storage ports 301.

### Embodiment 2

While the port assignment device 400 provided separately from the storage device 300 notifies the server devices 200 of the change of ports assigned to the targets in the first embodiment, a port assignment device having the function of the storage device 300 (or a storage device having the function of the port assignment device 400) will be described below as a second embodiment in accordance with the present invention, wherein elements already described in the first embodiment are indicated with the same reference numerals and repeated description thereof is omitted for brevity.

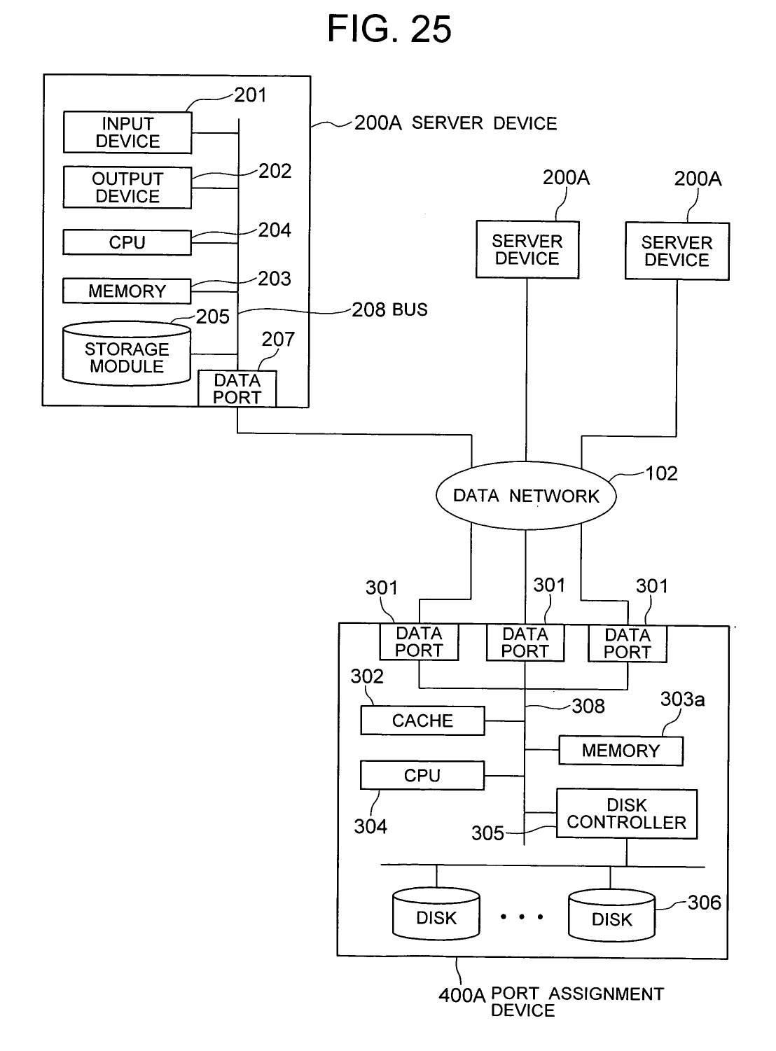

FIG. 25 is a schematic block diagram showing a computer system employing a port assignment device in accordance with a second embodiment of the present invention. As shown in FIG. 25, the computer system includes a plurality of (three in FIG. 25) server devices 200A and a port assignment device 400A which are connected together by a data network 102. The hardware configuration of the server device (external device) 200A is basically the same as that of the server device 200 shown in FIG. 1, except that the server device 200A does not have the management port 206 shown in FIG. 1. The hardware configuration of the port assignment device 400A is basically the same as that of the storage device 300 shown in FIG. 1, except that the port assignment device 400A does not have the management port 307 and programs and data stored in a memory 303a (load information storage module) are different from those stored in the memory 303 shown in FIG. 1.

Programs and data stored in a memory 203 of the server device 200A are basically the same as the memory contents shown in FIG. 2, except that the initiator iSNS client program 213 is not included. Therefore, the discovery process is executed by the CPU 204 by running the initiator process program 212.

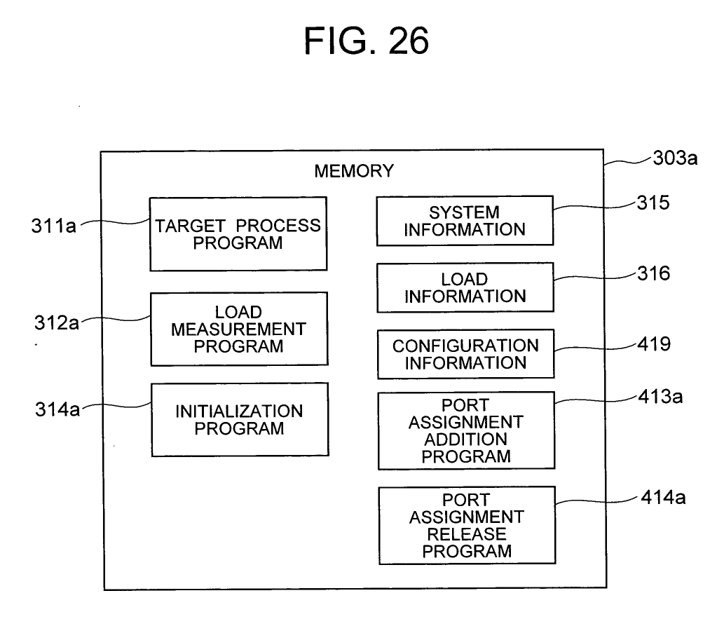

FIG. 26 is a block diagram showing memory contents of the memory 303a of the port assignment device 400A. The memory 303a has stored a target process program 311a, a load measurement program 312a, an initialization program 314a, system information 315, load information 316, configuration information 419, a port assignment addition program 413a, a port assignment release program 414a, etc.

The target process program 311a is a program for executing processes of the iSCSI protocol. The CPU 304 runs the target process program 311a and thereby executes the aforementioned processes of the target process program 311 shown in FIG. 4 while providing target information to an initiator when a request for the target information is received from the initiator.

The load measurement program 312a is a program for measuring the reception loads. The CPU 304 runs the load measurement program 312a and thereby executes the aforementioned processes of the load measurement program 312 shown in FIG. 4 while judging whether or not the reception load on each target has exceeded the maximum load 801 or fallen below the minimum load 802. Incidentally, the CPU 304 running the load measurement program 312a functions as a port load measurement module.

The initialization program 314a is a program for initializing the load information 316 and the configuration information 419. The CPU 304 runs the initialization program 314a and thereby sets initial values to the load information 316 and the configuration information 419.

The configuration information 419 is information indicating reception loads which have been set by the manager as the reference values to be referred to when the port assignment device 400A issues the log-in instruction or log-out instruction to a server device 200A. An example of the configuration information 419 has been shown in FIG. 8.

The port assignment addition program 413a is a program for newly assigning a storage port 301 to a target. The operation of the CPU 304 running the port assignment addition program 413a will be described in detail later. Incidentally, the CPU 304 running the port assignment addition program 413a functions as a new assignment processing module.

The port assignment release program 414a is a program for releasing the assignment of a storage port 301 to a target. The operation of the CPU 304 running the port assignment release program 414a will be described in detail later. Incidentally, the CPU 304 running the port assignment release program 414a functions as an assignment release processing module.

In the following, the operation of the server device 200A and the port assignment device 400A in the computer system of the second embodiment will be described in detail, in which the discovery process, the load measurement and load monitoring, and the port assignment will be explained in sequence.

First, the operation when an initiator of a server device 200A carries out the discovery process will be described (see FIG. 25 as needed). The process is carried out by the CPU 204 of the server device 200A by running the initiator process program 212. The server device 200A transmits a message inquiring the target information to the port assignment device 400A and thereafter receives the target information from the port assignment device 400A. The operation of the server device 200A in this process is the same as that of the server device 200 of the first embodiment shown in FIG. 11.

Meanwhile, the operation of the port assignment device 400A in this process is implemented by the CPU 304 running the target process program 311a. When the message inquiring the target information is received from the server device 200A, the port assignment device 400A notifies the server device 200A of an iSCSI name of each target and an IP address and a TCP port number for logging in to each target (target information defined in the port assignment device 400A). The operation of the port assignment device 400A in this process is the same as that of the port assignment device 400 shown in FIG. 12.

By the above operation, the user of the server device 200A can carry out a log-in by selecting a target and a storage port 301 by operating the input device 201 based on the obtained target information.

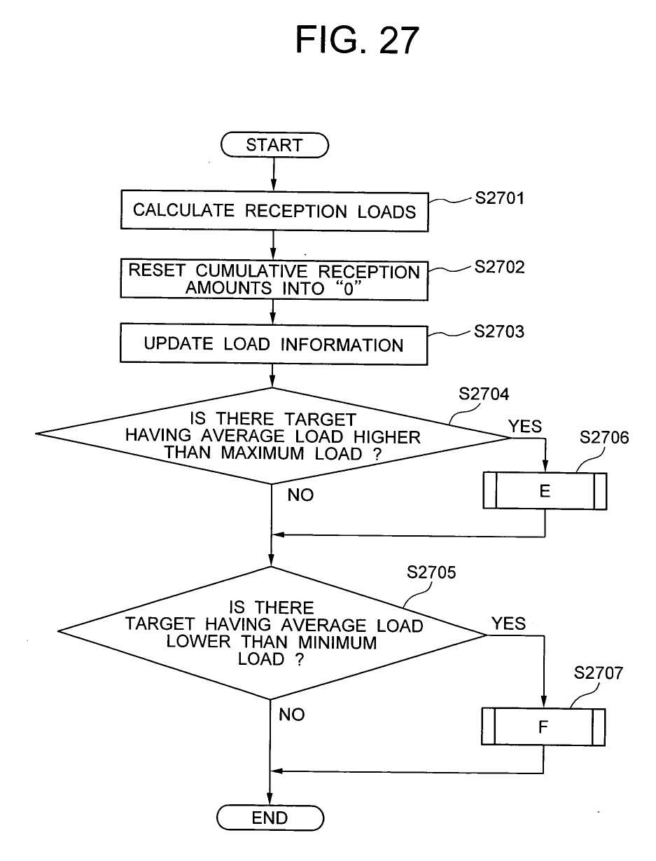

Next, the operation of the port assignment device 400A for executing the load measurement and load monitoring will be described referring to FIG. 27 (see FIG. 25 as needed). FIG. 27 is a flow chart showing a load measurement process and a load monitoring process executed by the port assignment device 400A. The processes are executed by the CPU 304 by running the load measurement program 312a stored in the memory 303a at prescribed time intervals.

The CPU 304 calculates the number of received bits per unit time regarding each storage port 301, each initiator (as a source) and each target (as a destination), as the reception loads (S2701). The CPU 304 has successively counted the cumulative reception amount of each storage port 301 regarding each initiator and each target and accumulated the amounts in the memory 303a by running the target process program 311a. Therefore, the CPU 304 calculates each reception load (the number of received bits per second, for example) by reading each cumulative reception amount from the memory 303a and dividing the cumulative reception amount by the prescribed time interval. The calculated reception loads are stored in the memory 303a in the form of the load information table shown in FIG. 6.

After calculating all the reception loads, the CPU 304 resets all the cumulative reception amounts stored in the memory 303a into “0” (S2702). Subsequently, the CPU 304 updates the load information 316 (reception loads) stored in the memory 303a into the calculated reception loads (S2703).

Subsequently, the CPU 304 refers to the load information 316 stored in the memory 303a and compares the average load 606 of each target contained in the load information 316 (see FIG. 6) with the maximum load 801 of each target contained in the configuration information 419 (see FIG. 8) stored in the memory 303a. In the comparison, if there exists a target whose average load 606 is higher than the maximum load 801 (S2704: YES), the-CPU 304 regards the target as a high load target and executes a subroutine E (explained later) to the high load target (S2706). Further, the CPU 304 compares the average load 606 of each target (see FIG. 6) with the minimum load 802 of each target contained in the configuration information 419 (see FIG. 8). In the comparison, if there exists a target whose average load 606 is lower than the minimum load 802 (S2705: YES), the CPU 304 regards the target as a low load target and executes a subroutine F (explained later) to the low load target (S2707).

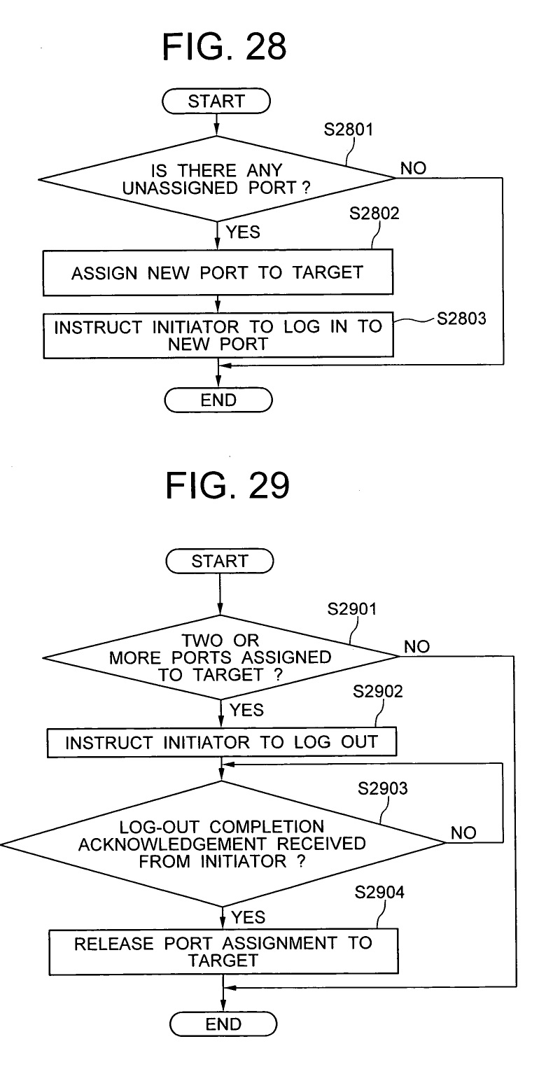

Next, the operation of the port assignment device 400A for assigning a port and issuing the log-in instruction to a server device 200A will be described referring to FIG. 28 (see FIG. 25 as needed). FIG. 28 is a flow chart showing a port assignment addition process and a log-in instruction process executed by the port assignment device 400A. The process is carried out by the CPU 304 by running the port assignment addition program 413a stored in the memory 303a. The process is the aforementioned subroutine E which is called in the step S2706 executed by the CPU 304 running the load measurement program 312a. Therefore, the CPU 304 has judged the target under consideration as a high load target (see FIG. 27) before the execution of the subroutine E. In other words, the average load 606 of the target (see FIG. 6) is higher than the maximum load 801 of the target (see FIG. 8).

The CPU 304 checks the correspondence between IP addresses 501 and iSCSI names 505 by referring to the system information 315 (see FIG. 5) stored in the memory 303a. If the CPU 304 judges that there is a storage port 301 that has not been assigned to any target (unassigned port) (S2801: YES), the CPU 304 newly assigns (adds) the unassigned port to the aforementioned high load target, that is, alters the port assignment to the target (S2802). The alteration process is executed by the CPU 304 by running the target configuration program 318 (unshown) stored in the memory 303a, by which the system information 315 is updated. When there are two or more unassigned ports, the CPU 304 assigns a randomly selected unassigned port to the high load target. If the CPU 304 judges that there is no storage port 301 as an unassigned port (S2801: NO), the process is ended. After the step S2802, the CPU 304 instructs a server device 200A (initiator) that has logged in to the high load target to log in to the newly assigned port (S2803). When there are two or more such initiators, the CPU 304 randomly selects an initiator to which the instruction is issued.

Next, the operation of the port assignment device 400A for releasing port assignment and issuing an log-out instruction to a server device 200A will be described referring to FIG. 29 (see FIG. 25 as needed). FIG. 29 is a flow chart showing a port assignment release process and a log-out instruction process executed by the port assignment device 400A. The process is carried out by the CPU 304 by running the port assignment release program 414a stored in the memory 303a. The process is the aforementioned subroutine F which is called in the step S2707 executed by the CPU 304 running the load measurement program 312a. Therefore, the CPU 304 has judged the target under consideration as a low load target (see FIG. 27) before the execution of the subroutine F. In other words, the average load 606 of the target (see FIG. 6) is lower than the minimum load 802 of the target (see FIG. 8).

The CPU 304 judges whether or not two or more storage ports 301 have been assigned to the low load target (S2901). If two or more storage ports 301 are judged to have been assigned to the low load target (S2901: YES), the CPU 304 instructs a server device 200A (initiator) that has logged in to a storage port 301 randomly selected from the two or more storage ports 301 to log out of the connection using the storage port 301 (S2902). If the CPU 304 judged that one or less storage ports 301 have been assigned to the low load target (S2901: NO), the process is ended.

When an acknowledgement message (indicating the completion of the log-out) is received from the server device 200A (initiator) (S2903: YES), the CPU 304 releases the assignment of the storage port 301 to the low load target (S2904). If the acknowledgement message (indicating the completion of the log-out) is not received from the server device 200A (initiator) (S2903: NO), the CPU 304 waits until the acknowledgement message is received.

In the second embodiment described above, the port assignment device 400A is provided with both the storage function and the port assignment function, by which the composition of the computer system can be simplified and the management network employed in the first embodiment can be left out.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

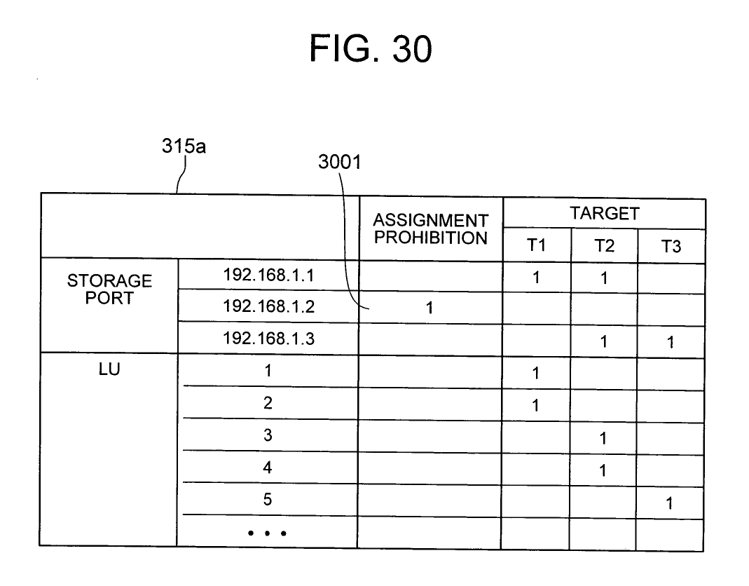

For example, while any storage port 301 can be newly assigned to a target and the assignment of any storage port 301 to a target can be released in the above embodiments, the port assignment device may also be configured to allow the manager to prohibit dynamic assignment of a particular storage port 301 to a target. FIG. 30 is a table showing an example of the system information employed in this case (cf. FIG. 5). In the system information 315a shown in FIG. 30, an assignment prohibition flag “1” can be set to a desired storage port 301 as seen in a cell 3001. The assignment prohibition flag “1” set in the cell 3001 means that the manager has prohibited the assignment of the storage port 301 having the IP address “192.168.1.2”.

In the case where the “assignment prohibition” setting is allowed, the operation of the storage device 300 in the system information update process becomes different from that in the first embodiment. In the step S1301 (see FIG. 13), the CPU 304 checks IP addresses of all the available storage ports 301 of the storage device 300 and compares the IP addresses with the system information 315a; however, storage ports 301 to which the assignment prohibition flag “1” has been set are not regarded as the objects of the comparison. Consequently, the load information 316 does not include information on the assignment-prohibited ports.

By such a configuration of the port assignment device, the manager is allowed to prohibit the dynamic assignment of particular storage ports 301 as needed and keep the assignment-prohibited ports as reserve ports. The reserve ports can be used as ports exclusively for backup, ports for fixed connection with particular server devices 200, etc.

Further, while an unassigned port is newly assigned to a target when the load on the target has become too high (specifically, when the average load 606 on the target per storage port has become too high) in the above embodiments, the port assignment device may also be configured to assign an unassigned port to a particular target when failure has occurred to a storage port 301 that has been assigned to the target.

In such a configuration, the operation of the storage device 300 in the system information update process becomes different from that in the first embodiment. In the step S1301 (see FIG. 13), the CPU 304 checks IP addresses of all the available storage ports 301 of the storage device 300 and validity/invalidity of each of the ports. A storage port 301 having a failure (invalidity of the port) can be detected by a ping command, a SNMP (Simple Network Management Protocol) trap (event notification), etc.

When a storage port 301 having a failure is detected, the CPU 304 carries out the assignment prohibition setting (updates the system information) by writing the value “1” in the “assignment prohibition” cell for the storage port 301 in the system information 315a shown in FIG. 30. Even when a particular storage port 301 has become unusable, the storage device 300 automatically alters the port assignment and thereby the server device 200 can continue data input/output.

While the port assignment device executes the port assignment process independently of the discovery process in the above embodiments, the present invention is not restricted to such a scheme. For example, the port assignment device 400 may alter the port assignment to each target so as to distribute the loads on the ports over the ports based on the load information 416 when there is an inquiry from a server device 200 while instructing the server device 200 to log in to a proper port after the alteration.

In the above embodiments, when the load on a particular target has become too high, a new port is assigned to the target only when there exists an unassigned port. However, the port assignment device may also be configured to release the assignment of a storage port 301 to another target under a low load and reassign the released port to the high load target (or to leave the assignment of the port to the low load target as it is and additionally assign the port to the high load target) in the case where no unassigned port exists, for example.

While the loads on the storage ports are measured at prescribed time intervals in the above embodiments, the loads may also be measured when input/output performance has dropped, when an increase in the input/output load caused by an application is expected, etc.

The port assignment device may also employ priorities previously set by the manager to the targets so that targets to be assigned the unassigned ports can be determined when the number of unassigned ports is insufficient relative to the number of high load targets. In this case, the port assignment device assigns storage ports 301 preferentially to targets of high priorities.

Further, in cases where a storage port that has been assigned to a low load target is assigned to a high load target when the number of unassigned ports is insufficient, if there exist two or more low load targets, the storage port to be assigned to the high load target may be selected preferentially from storage ports that have been assigned to one of the low load targets having the lowest priority therein.

While the port assignment device and the storage device were integrated into a device in the second embodiment, integration of the port assignment device and the server device into a device is also possible. Further, it is possible in the first embodiment to let the storage device execute the alteration of port assignment based on the loads while letting the port assignment device execute name management and the issuance of the log-in/log-out instructions based on notifications from the storage device.

While the above embodiments have been explained taking the iSCSI as an example of the protocol for transmitting/receiving data in an IP-SAN, other protocols may also be employed in the present invention for the data communication in IP-SANs:

It should be further understood by those skilled in the art that although the foregoing description has been made on embodiments of the invention, the invention is not limited thereto and various changes and modifications may be made without departing from the spirit of the invention and the scope of the appended claims.

1. A port assignment device which assigns a plurality of ports of a storage device, storing data sent from one or more external devices connected via a network in a plurality of storage modules and logically managing the data in the storage modules by a plurality of targets processing initiator commands sent from the external devices, to the targets, comprising:
a load information storage module which stores load information indicating a load on each port assigned to each of the targets; and
a processing module which issues an instruction for altering the port assignment to each target so as to disperse the load on each port based on the load information stored in the load information storage module.

2. The port assignment device according to claim 1, wherein in the issuance of the instruction for altering the port assignment to each target, the processing module issues an instruction for newly assigning an unused port to a target if an average load on the target per port obtained from the load information stored in the load information storage module is judged to have exceeded an upper limit.

3. The port assignment device according to claim 1, wherein in the issuance of the instruction for altering the port assignment to each target, the processing module issues an instruction for releasing the assignment of one of a plurality of ports assigned to a target if an average load on the target per port obtained from the load information stored in the load information storage module is judged to have fallen below a lower limit.

4. The port assignment device according to claim 2, wherein the processing module instructs an external device that outputted the initiator command to a port under a load exceeding the upper limit to log in through the newly assigned unused port.

5. The port assignment device according to claim 3, wherein the processing module instructs an external device that has logged in through the released port to log out of a connection using the released port.

6. The port assignment device according to claim 1, wherein part of the ports to be assigned to targets have previously be prohibited by a manager from being assigned to a target.

7. The port assignment device according to claim 1, wherein the processing module issues an instruction for prohibiting the assignment of one of the ports when failure occurring to the port is detected.

8. The port assignment device according to claim 1, further comprising a port load measurement module which measures the loads on the ports with prescribed timing and generates the load information stored in the load information storage module based on result of the measurement.

9. A port assignment device which assigns a plurality of ports of a storage device, storing data sent from one or more external devices connected via a network in a plurality of storage modules and logically managing the data in the storage modules by a plurality of targets processing initiator commands sent from the external devices, to the targets, comprising:
a load information storage module which stores load information indicating a load on each port assigned to each of the targets; and
a processing module which issues an instruction for altering the port assignment to each target so as to disperse the load on each port based on the load information stored in the load information storage module while instructing an external device to log in to a proper port after the alteration when access is made by the external device.

10. A port assignment device which assigns a plurality of ports of a storage device, storing data sent from one or more external devices connected via a network in a plurality of storage modules and logically managing the data in the storage modules by a plurality of iSCSI targets processing iSCSI initiator commands sent from the external devices, to the targets, comprising:
a load information storage module which stores load information indicating a load on each port assigned to each of the iSCSI targets;
a new assignment processing module which issues an instruction for newly assigning an unused port to an iSCSI target if an average load on the ISCSI target per port obtained from the load information stored in the load information storage module is judged to have exceeded an upper limit; and
an assignment release processing module which issues an instruction for releasing the assignment of one of a plurality of ports assigned to an iSCSI target if an average load on the iSCSI target per port obtained from the load information stored in the load information storage module is judged to have fallen below a lower limit.

11. A port assignment method for a port assignment device which assigns a plurality of ports of a storage device, storing data sent from one or more external devices connected via a network in a plurality of storage modules and logically managing the data in the storage modules by a plurality of targets processing initiator commands sent from the external devices, to the targets, wherein the port assignment device executes:
a storage step for storing load information indicating a load on each port assigned to each of the targets in a load information storage module; and
an alteration step for issuing an instruction for altering the port assignment to each target so as to disperse the load on each port based on the load information stored in the storage step.

12. The port assignment method according to claim 11, wherein the alteration step includes:
a judgment step for making a judgment in the issuance of the instruction for altering the port assignment to each target whether or not an average load on a target per port obtained from the load information stored in the load information storage module has exceeded an upper limit; and
a new assignment step for issuing an instruction for newly assigning an unused port to the target if the average load on the target per port is judged to have exceeded the upper limit in the judgment step.

13. The port assignment method according to claim 11, wherein the alteration step includes:
a judgment step for making a judgment in the issuance of the instruction for altering the port assignment to each target whether or not an average load on a target per port obtained from the load information stored in the load information storage module has fallen below a lower limit; and
an assignment release step for issuing an instruction for releasing the assignment of one of a plurality of ports assigned to the target if the average load on the target per port is judged to have fallen below the lower limit in the judgment step.

14. The port assignment method according to claim 12, further comprising a log-in instruction step for instructing an external device that outputted the initiator command to a port under a load exceeding the upper limit to log in through the newly assigned unused port.

15. The port assignment method according to claim 13, further comprising a log-out instruction step for instructing an external device that has logged in through the released port to log out of a connection using the released port.
